(19) United States
(12) Patent Application Publication
(10) Pub. No.: US 2015/0352916 A1
(43) Pub. Date: Dec. 10, 2015

(54) Device and Method for Towing Vehicles Having an Air Suspension

(71) Applicant: Joseph Towner, Portland, MI (US)

(72) Inventor: Joseph Towner, Portland, MI (US)

(21) Appl. No.: 14/616,790

(22) Filed: Feb. 9, 2015

Related U.S. Application Data
(60) Provisional application No. 62/008,546, filed on Jun. 6, 2014.

(51) Int. Cl. B60D 1/58; B60D 1/46; B60P 3/12

(52) U.S. Cl. CPC B60D 1/58; B60P 3/125; B60D 1/465

(57) ABSTRACT

A device and associated method of use for towing a vehicle having an air suspension is provided. The present invention is a substantially cylindrical coupling unit have a first end adapted to engage with a receiver of an underlift towing device, a second end adapted to engage with a slot disposed beneath the certain models of suspensions, and a coaxial collar disposed therebetween. The present coupling unit replaces underlift forks that are conventionally used with underlift towing devices. By engaging with the slot beneath the air suspension, rather than the axle as with the underlift forks, the present invention avoids the potential for the underlift device to bottom out against the underbody of the vehicle to be towed.

### CROSS REFERENCE TO RELATED APPLICATION

This application claims the benefit of U.S. Provisional Application No. 62/008,546 filed on Jun. 6, 2014. The above identified patent application is herein incorporated by reference in its entirety to provide continuity of disclosure.

### FIELD OF THE INVENTION

The present invention relates to a device and method for assisting in towing vehicles. More specifically, the present invention relates to a device and method for assisting in towing vehicles having an air suspension that avoids causing damage to any components disposed on the underbody of the vehicle.

### BACKGROUND OF THE INVENTION

There are two main types of underlift towing systems: wheel lift systems and axle fork systems. Conventional axle fork towing systems utilize a hydraulic lifting device having a pair of arms with receiver slots disposed at the ends of the arms. An axle fork is placed within each of the receivers, wherein the configuration of the axle fork corresponds to the design of the axle of vehicle to be towed. The hydraulic lifting device is then positioned so that the axle forks engage with the vehicle's axle on either side of the differential. The hydraulic lifting device can then be raised, lifting the vehicle by the axle.

Although generally effective, towing a vehicle using a conventional axle fork systems has numerous disadvantages. First, it can be challenging to properly position the hydraulic lifting device so that the axle forks properly engage with the vehicle's axle. Second, if the axle forks are not placed properly, then the T-bar of the hydraulic lifting device can bottom out against the underbody of the vehicle. This can cause damage to a number of different components disposed on the underbody of the vehicle, including the temperature sensor disposed on many rear differentials. Replacing the temperature sensor can be very costly and time-consuming. Some models of vehicles, including Peterbilt and Kenworth semi-tractors, have a slot disposed beneath their air suspensions with which a coupling device could engage, obviating the need to utilize difficult-to-position axle forks. Therefore, there is a need in the prior art for an improved means for towing a vehicle utilizing a hydraulic underlift towing device that avoids the disadvantages of the prior art.

### SUMMARY OF THE INVENTION

The following summary is intended solely for the benefit of the reader and is not intended to be limiting in any way. In view of the foregoing disadvantages inherent in the known types of underlift forks, wheel lifts, and accessories associated therewith now present in the prior art, the present invention provides an underlift fork accessory wherein the same can be utilized for providing convenience for the user when towing certain models of vehicles having air suspensions with a slot with which a coupling unit can engage, replacing conventional axle forks. The present system comprises a substantially cylindrical coupling unit have a first end adapted to engage with a receiver of an underlift towing device, a second end adapted to engage with a slot disposed beneath the certain models of suspensions, and a coaxial collar disposed therebetween. The present coupling unit replaces underlift forks that are conventionally used with underlift towing devices. By engaging with the slot beneath the air suspension, rather than the axle as with the underlift forks, the present invention avoids the potential for the underlift device to bottom out against the underbody of the vehicle to be towed.

Although the present disclosure discusses the present invention as used with Peterbilt and Kenworth semi-tractors, these models of vehicles are chosen solely due to the configuration of their air-ride suspensions. Their air-ride suspensions have a slot or aperture disposed beneath the air springs with which the present coupling unit can engage and then from which the underlift towing device can lift the vehicle without causing damage to the air ride suspension or any of the other components of the vehicle. However, any other model of vehicle having such an air ride suspension is suitable for use with the present device and method of use.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of the present invention.

FIG. 2A shows a perspective view of the present invention being inserted into the receivers of an underlift fork unit.

FIG. 2B shows a perspective view of an underlift fork unit being positioned and raised so that the present invention engages with the slots disposed in the vehicle frame adjacent to the air suspension.

FIG. 2C shows a perspective view of the present invention placed within a slot disposed in the vehicle frame adjacent to the air suspension.

FIG. 2D shows a side view of the present invention placed within a slot disposed in the vehicle frame adjacent to the air suspension.

### DETAILED DESCRIPTION OF THE INVENTION

Reference is made herein to the attached drawings. Like reference numerals are used throughout the drawings to depict like or similar elements of the underlift fork-air suspension adapter. For the purposes of presenting a brief and clear description of the present invention, the preferred embodiment will be discussed as used for towing a vehicle having an air suspension of a certain design wherein a slot or aperture is disposed beneath the air springs. The figures are intended for representative purposes only and should not be considered to be limiting in any respect.

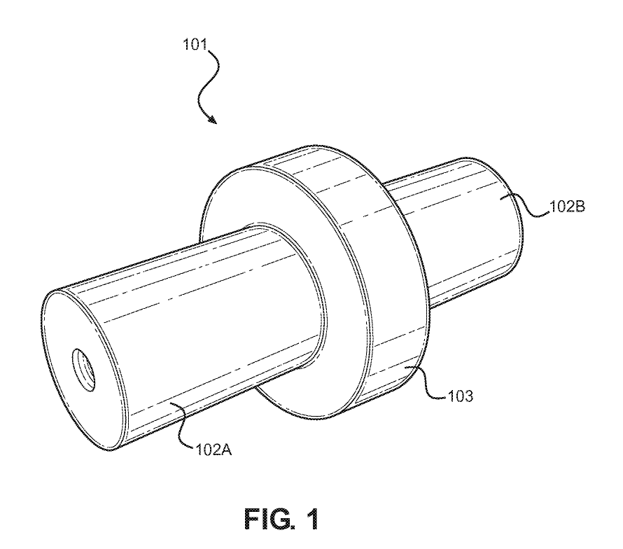

Referring now to FIG. 1, there is shown a perspective view of the present invention. The present invention comprises a coupling unit 101 and a method of using the coupling unit 101 to tow a vehicle. The coupling unit 101 comprises a first end 102A, a second end 102B, and a collar 103 coaxially disposed therebetween. The first end 102A, second end 102B, and collar 103 all comprise a cylindrical shape. In one embodiment of the present invention, the first end 102A and the second 1028 have an equal cross-sectional area, i.e. the diameters of the cylindrical ends 102A, 1028 are equal. In an alternative embodiment of the present invention, the first end 102A and the second end 102B have different cross-sectional areas, i.e. the diameters of the cylindrical ends 102A, 102B are unequal. In all embodiments of the present invention, the collar 103 has a larger cross-sectional area than both of the ends 102A, 1028, thereby allowing it to project from the first and second ends 102A, 1028.

The present coupling unit 101 is adapted to replace conventional axle forks, which are insertable into receivers disposed on the underlift towing devices. In one embodiment of the present invention, the second end 102B has a second diameter and is adapted to engage with the receivers of the underlift towing device and the first end 102A has a first diameter and is adapted to engage with a slot disposed on the air suspension of the vehicle. In this embodiment, the second diameter is equal to the diameter of receivers of the underlift towing unit within a close tolerance, creating fitment between the two components and thereby ensuring that the coupling unit 101 is securely held therein. As conventional receivers are cylindrical in shape and have a diameter of two-inches, the second end 1028 is cylindrical in shape in conformity with the receivers and the second diameter can in turn be two inches in order to properly engage with industry-standard receivers.

In an alternative embodiment of the present invention, the present coupling unit 101 is designed so that both of the first or the second ends 102A, 1028 can engage with the receiver. Therefore, the first and the second ends 102A, 1028 both comprise a cylindrical shape. However, no claim is made as to a specific diameter for the first and second ends 102A, 1028 and the first and second ends 102A, 1028 can be provided in a number of different shapes or sizes. The present disclosure contemplates embodiments of the present invention where the ends 102A, 102B are both interchangeable and non-interchangeable.

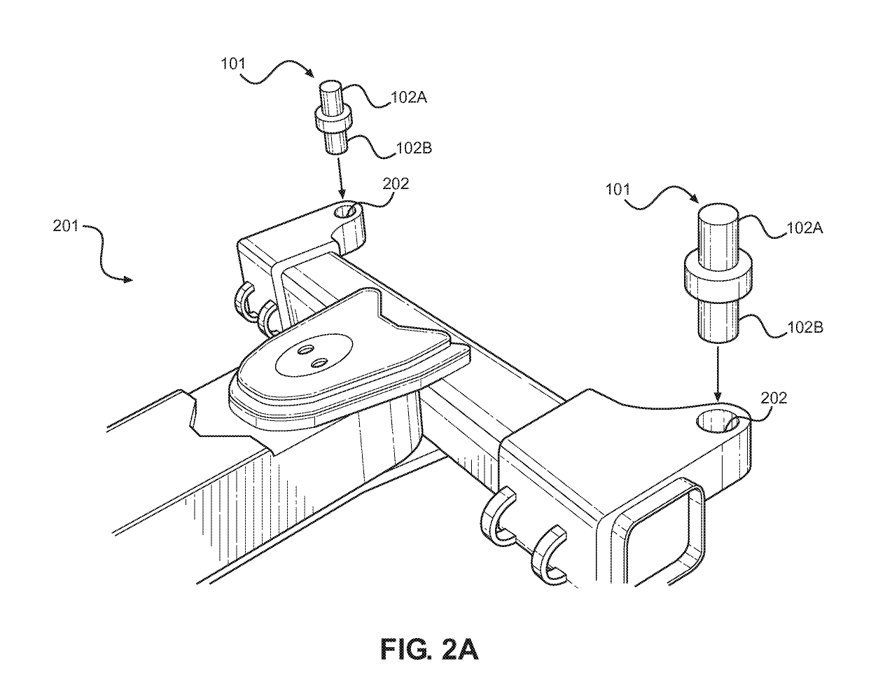

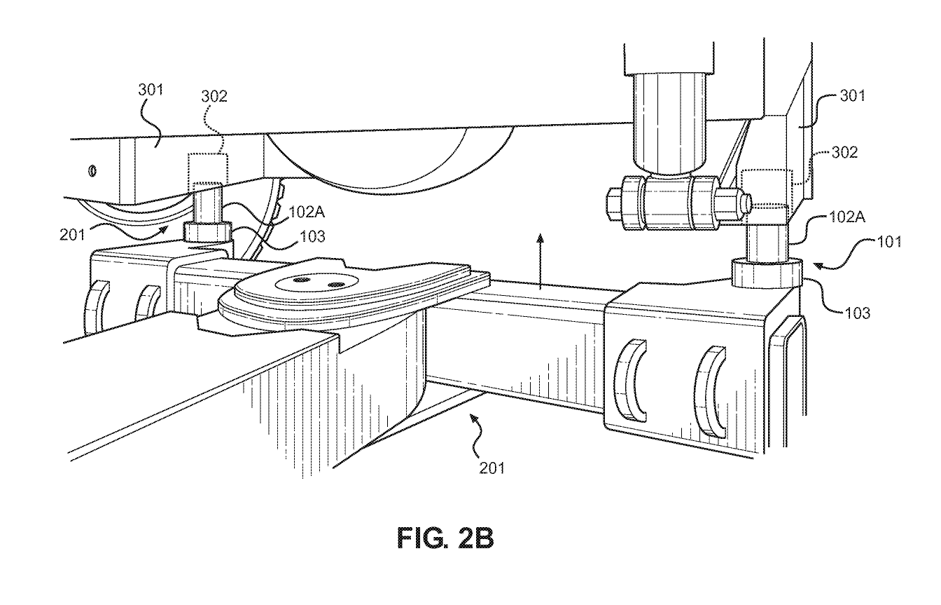

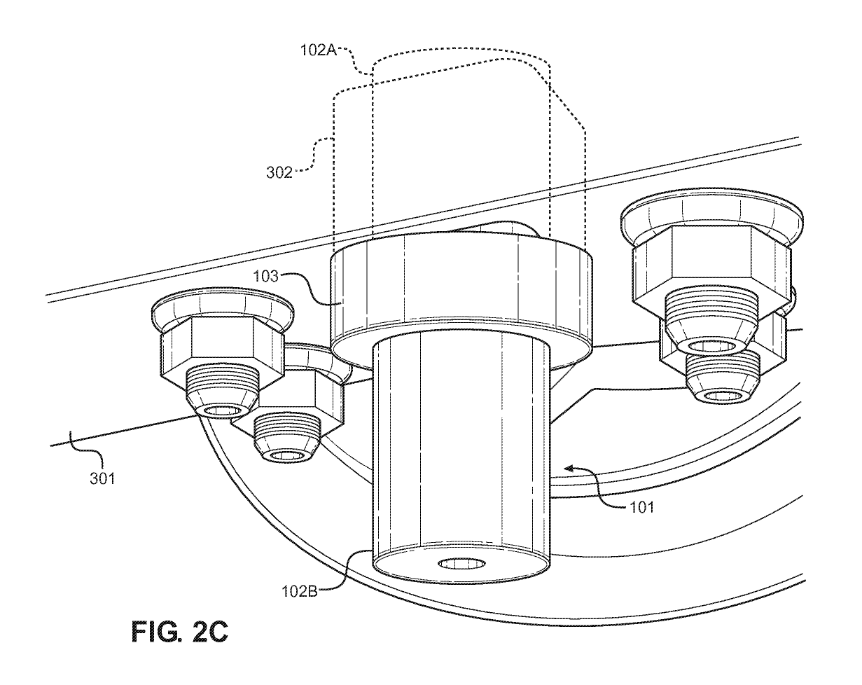

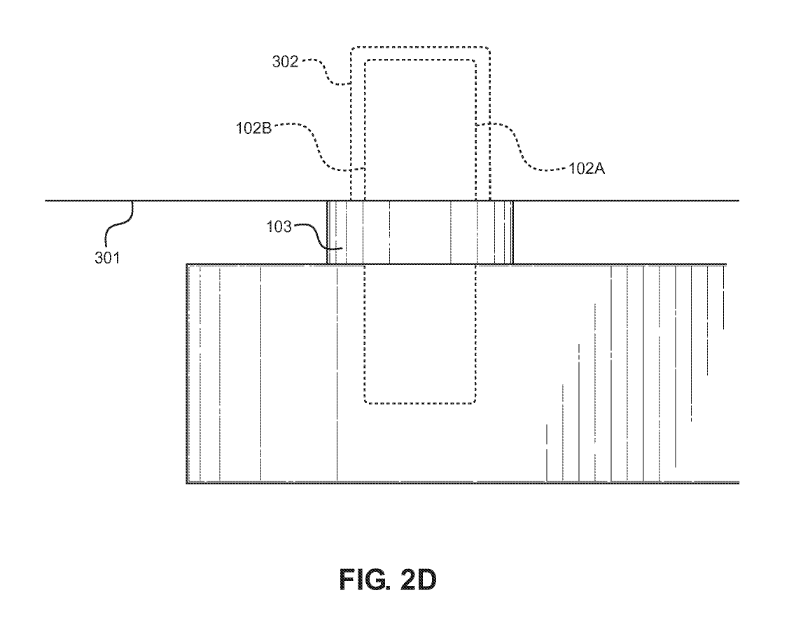

Referring now to FIGS. 2A-2D, there are shown views of the various stages of use of the present invention. The present method of towing a vehicle having a certain model of air suspension utilizes the coupling unit 101, as described above, to replace the conventional axle forks of an underlift towing unit 201. To begin, the user places one or more coupling units 101 within the receivers 202 of the underlift towing unit 201. The receivers 202 are cylindrical slots disposed at the ends of the arms of the underlift towing unit 201. FIG. 2A shows the second end 1028 of the coupling unit 101 being placed within the receivers 202; however, the first end 102A and second end 1028 are preferably of equal shape and dimensions, therefore either of the ends 102A, 102B can be interchangeably placed within the receivers 202.

Once the coupling units 101 have been secured within the receivers 202, the users then align the coupling units 101 with the slots 302 disposed beneath the air springs of the air-ride suspension 301. Once the coupling units 101 are aligned therewith, the user can then raise the hydraulic underlift towing device 201, thereby causing the coupling units 101 to engage with the air suspension slots 302. The collar 103 preferably has a cross-sectional area greater than the cross-sectional area of the air suspension slot 302 with which the coupling unit 101 is engaging, preventing the collar 103 from entering the air suspension slot 302 and thereby ensuring that the collar 103 remains positioned between the underbody of the vehicle and the arms of the underlift towing unit. The collar 103 creates an offset between the underbody of the vehicle and the underlift towing device, preventing the arms of the underlift towing unit from making contact with the underbody of the vehicle and causing damage thereto. In an exemplary embodiment of the present invention, the diameter of the collar 103 is equal to three-and-one-half inches and the height of the collar 103 is one and one-eighths of an inch. Once the coupling units 101 are engaged with the air suspension slots 302, the users can then continue to raise the underlift towing unit to lift the axle of the vehicle off of the ground so that the vehicle can then be towed.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A method of towing a vehicle utilizing an underlift unit, comprising the steps of:
inserting a coupling unit into a receiver of the underlift unit, the coupling unit comprising a first end adapted to engage with a slot disposed on a bottom of an air suspension unit of the vehicle, a second end adapted to engage with the receiver, and a collar;
positioning the wheel lift unit such that the coupling unit is aligned with the slot disposed on the bottom of the air suspension unit of the vehicle;
raising the wheel lift unit such that the second end engages with the slot;
wherein the coupling unit prevents contact between the wheel lift unit and a frame of the vehicle.

2) The method of towing a vehicle utilizing an underlift unit of claim 1, wherein the first end comprises a cylindrical member and the second end comprises a cylindrical member.

3) The method of towing a vehicle utilizing an underlift unit of claim 1, wherein a cross-sectional area of the first end is less than a cross-sectional area of the second end.

4) The method of towing a vehicle utilizing an underlift unit of claim 1, wherein a diameter of the second end is equal to a diameter of the receiver within a closer tolerance.

5) The method of towing a vehicle utilizing an underlift unit of claim 1, wherein a diameter of the second end is equal to two inches.

6) The method of towing a vehicle utilizing an underlift unit of claim 1, wherein the collar is coaxial to the first end and the second end.

7) A coupling unit for an underlift unit, comprising:
a first end adapted to engage with a slot disposed on a bottom of an air suspension unit of the vehicle, a second end adapted to engage with the receiver, and a collar;
wherein the coupling unit prevents contact between the underlift unit and a frame of a vehicle.

8) The coupling unit of claim 7, wherein the first end comprises a cylindrical member and the second end comprises a cylindrical member.

9) The coupling unit of claim 7, wherein a cross-sectional area of the first end is less than a cross-sectional area of the second end.

10) The coupling unit of claim 7, wherein a diameter of the second end is equal to a diameter of the receiver within a closer tolerance.

11) The coupling unit of claim 7, wherein a diameter of the second end is equal to two inches.

12) The coupling unit of claim 7, wherein the collar is coaxial to the first end and the second end.
